(19) United States
(12) Patent Application Publication
(10) Pub. No.: US 2018/0257369 A1
(43) Pub. Date: Sep. 13, 2018

(54) PRINTING APPARATUS AND ADJUSTMENT METHOD THEREOF

(71) Applicant: CANON KABUSHIKI KAISHA, Tokyo (JP)

(72) Inventor: Toshiki Takeuchi, Tokyo (JP)

(21) Appl. No.: 15/903,593

(22) Filed: Feb. 23, 2018

(30) Foreign Application Priority Data
Mar. 8, 2017 (JP) 2017-044225

(51) Int. Cl. B41J 2/005; B41J 2/01; B41J 29/02

(52) U.S. Cl. CPC B41J 2/0057; B41J 2002/012; B41J 29/02; B41J 2/01

(57) ABSTRACT

Satisfactory image transfer is implemented in a printing apparatus configured to nip a print medium by two rotating bodies and transfer an image to the print medium according to an embodiment of this invention. For this purpose, the printing apparatus that transfers an image to a print medium nipped by the two rotating bodies of the first rotating body on which an image is formed by a printhead and the second rotating body which conveys the print medium, and print the image is adjusted as follows. That is, a clearance between the first rotating body and the second rotating body is obtained, and based on the obtained clearance, an axis-to-axis distance between the rotating shaft of the first rotating body and the rotating shaft of the second rotating body is adjusted.

### BACKGROUND OF THE INVENTION

### Field of the Invention

The present invention relates to a printing apparatus and an adjustment method thereof, and particularly to, for example, a printing apparatus and an adjustment method thereof that transfer an image formed by discharging ink to a transfer member to a print medium and print the image.

### Description of the Related Art

There is conventionally known, for example, a printing apparatus configured to discharge or apply a printing material such as ink to a transfer member, form an image on the transfer member, transfer the image to a print medium, and print the image. The apparatus thus configured conveys the print medium to a portion between the transfer member and a pressurizing drum provided separately from the transfer member, applies a printing pressure on the print medium, and transfers the image from the transfer member to the print medium.

For example, an apparatus disclosed in Japanese Patent Laid-Open No. 2008-212826 includes a mechanism that adjusts a printing pressure between a blanket drum serving as transfer members, and a pressurizing drum.

According to Japanese Patent Laid-Open No. 2008-212826, since each component of the apparatus undergoes thermal expansion owing to a temperature increase and in addition, the printing pressure changes from a setting value, the apparatus includes a temperature measurement device for a printing unit, and adjusts the printing pressure based on a measured temperature.

Furthermore, Japanese Patent Laid-Open No. 2010-204222 also discloses an image forming apparatus having an arrangement for nipping a print medium by two rollers, and heating and pressurizing it, and an arrangement for adjusting a pressurization force.

In an arrangement disclosed in Japanese Patent Laid-Open No. 2008-212826, however, the temperature measurement device only measures temperatures near the surfaces of the blanket drum and pressurizing drum serving as rotating bodies and does not measure the outer diameter itself of each drum, being incapable of setting a clearance between the blanket drum and the pressurizing drum appropriately. Moreover, the apparatus disclosed in Japanese Patent Laid-Open No. 2010-204222 detects a variation in outer diameter of only a roller on a side with a heating source and cannot cope with a case in which both two opposite rollers undergo thermal expansion.

In an arrangement for nipping a print medium by two rotating bodies, in particular, if the diameters of the two rotating bodies are large, a distance between the two rollers changes largely even by slight thermal expansion. Consequently, a printing pressure (transfer pressure) applied to the print medium is not stabilized. In an apparatus configured to transfer an image from a transfer member, this greatly influences the quality of the transferred image.

### SUMMARY OF THE INVENTION

Accordingly, the present invention is conceived as a response to the above-described disadvantages of the conventional art.

For example, a printing apparatus and an adjustment method thereof according to this invention are capable of nipping a print medium by two rotating bodies and implementing satisfactory image transfer also in an arrangement for transferring an image to the print medium.

According to one aspect of the present invention, there is provided a printing apparatus comprising: a first rotating body on which an image is formed by a printhead; a second rotating body configured to convey a print medium; an obtaining unit configured to obtain a clearance between the first rotating body and the second rotating body; an adjustment unit configured to adjust an axis-to-axis distance between a rotating shaft of the first rotating body and a rotating shaft of the second rotating body based on the clearance obtained by the obtaining unit; and a transfer unit configured to transfer the image formed on the first rotating body to the print medium conveyed by the second rotating body and print the image.

According to another aspect of the present invention, there is provided an adjustment method of a printing apparatus that includes a first rotating body on which an image is formed by a printhead, a second rotating body configured to convey a print medium, and a transfer unit configured to transfer the image formed on the first rotating body to the print medium conveyed by the second rotating body and print the image, the method comprising: obtaining a clearance between the first rotating body and the second rotating body; and adjusting an axis-to-axis distance between a rotating shaft of the first rotating body and a rotating shaft of the second rotating body based on the clearance by the obtaining.

The invention is particularly advantageous since it is possible to implement the satisfactory image transfer by adjusting a distance between the two rotating bodies and stabilizing a transfer pressure.

Further features of the present invention will become apparent from the following description of exemplary embodiments (with reference to the attached drawings).

### BRIEF DESCRIPTION OF THE DRAWINGS

FIG. 1 is a schematic view showing a printing system according to an exemplary embodiment of the present invention;

FIG. 2 is a perspective view showing a print unit;

FIG. 3 is an explanatory view showing a displacement mode of the print unit in FIG. 2;

FIG. 4 is a block diagram showing a control system of the printing system in FIG. 1;

FIG. 5 is a block diagram showing the control system of the printing system in FIG. 1;

FIG. 6 is an explanatory view showing an example of the operation of the printing system in FIG. 1;

FIG. 7 is an explanatory view showing an example of the operation of the printing system in FIG. 1;

FIG. 8 shows detailed arrangement of the transfer member and the pressurizing drum, and positional relationship between them;

FIGS. 9A and 9B are conceptual views showing an axis-to-axis distance adjustment mechanism;

FIGS. 10A and 10B are conceptual views showing an axis-to-axis distance adjustment mechanism;

FIGS. 11A and 11B are conceptual views showing an axis-to-axis distance adjustment mechanism; and

FIG. 12 is a flowchart showing axis-to-axis distance adjustment process.

### DESCRIPTION OF THE EMBODIMENTS

Exemplary embodiments of the present invention will now be described in detail in accordance with the accompanying drawings. Note that in each drawing, arrows X and Y indicate horizontal directions perpendicular to each other, and an arrow Z indicates a up/down direction.

<Description of Terms>

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans.

Also, the term “print medium (or sheet)” not only includes a paper sheet used in common printing apparatuses, but also broadly includes materials, such as cloth, a plastic film, a metal plate, glass, ceramics, wood, and leather, capable of accepting ink.

Furthermore, the term “ink” (to be also referred to as a “liquid” hereinafter) should be broadly interpreted to be similar to the definition of “print” described above. That is, “ink” includes a liquid which, when applied onto a print medium, can form images, figures, patterns, and the like, can process the print medium, and can process ink. The process of ink includes, for example, solidifying or insolubilizing a coloring agent contained in ink applied to the print medium. Note that this invention is not limited to any specific ink component, however, it is assumed that this embodiment uses water-base ink including water, resin, and pigment serving as coloring material.

Further, a “print element (or nozzle)” generically means an ink orifice or a liquid channel communicating with it, and an element for generating energy used to discharge ink, unless otherwise specified.

An element substrate for a printhead (head substrate) used below means not merely a base made of a silicon semiconductor, but an arrangement in which elements, wirings, and the like are arranged.

Further, “on the substrate” means not merely “on an element substrate”, but even “the surface of the element substrate” and “inside the element substrate near the surface”. In the present invention, “built-in” means not merely arranging respective elements as separate members on the base surface, but integrally forming and manufacturing respective elements on an element substrate by a semiconductor circuit manufacturing process or the like.

<Printing System>

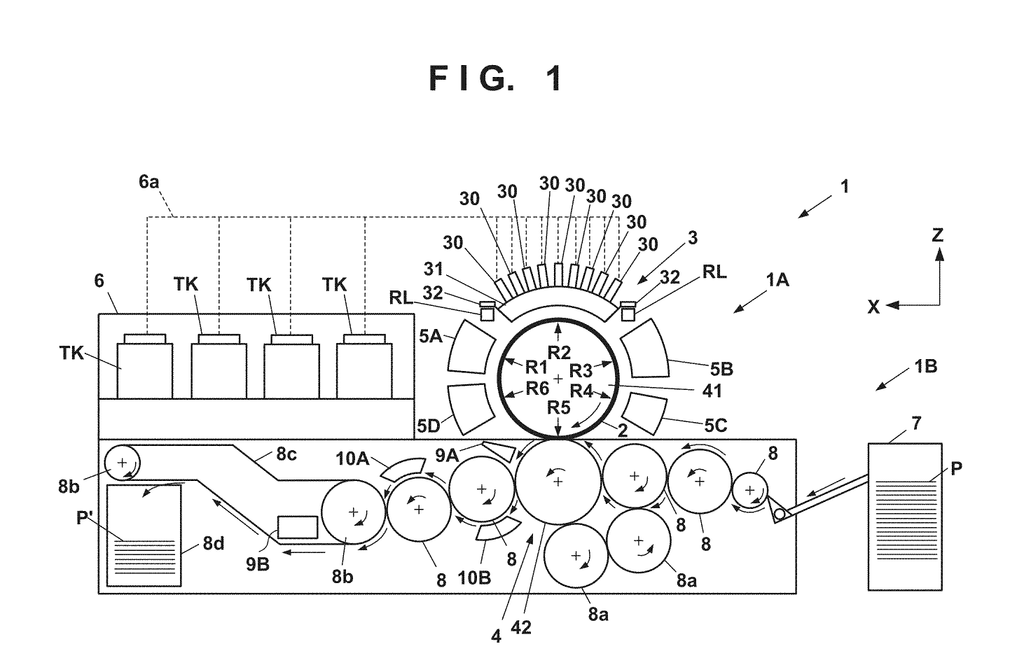

FIG. 1 is a front view schematically showing a printing system 1 according to an embodiment of the present invention. The printing system 1 is a sheet inkjet printer that forms a printed product P′ by transferring an ink image to a print medium P via a transfer member 2. The printing system 1 includes a printing apparatus 1A and a conveyance apparatus 1B. In this embodiment, an X direction, a Y direction, and a Z direction indicate the widthwise direction (total length direction), the depth direction, and the height direction of the printing system 1, respectively. The print medium P is conveyed in the X direction.

<Printing Apparatus>

The printing apparatus 1A includes a print unit 3, a transfer unit 4, peripheral units 5A to 5D, and a supply unit 6.

<Print Unit>

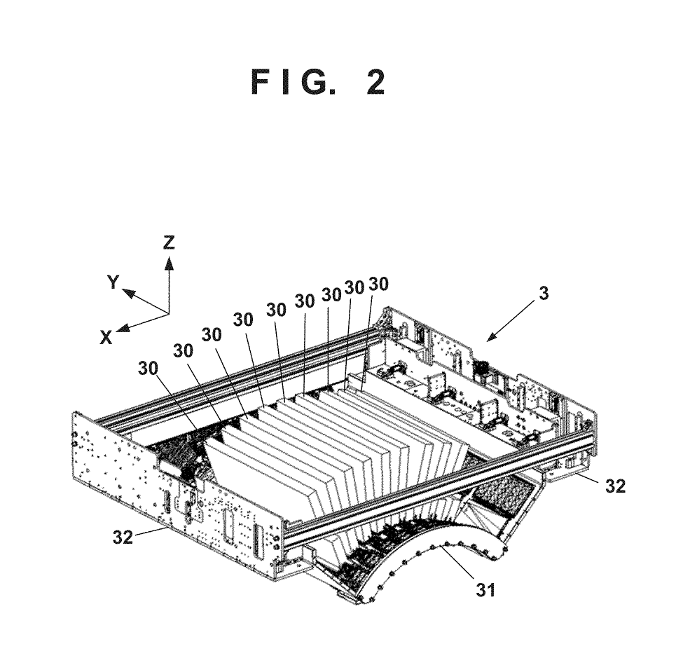

The print unit 3 includes a plurality of printheads 30 and a carriage 31. A description will be made with reference to FIGS. 1 and 2. FIG. 2 is perspective view showing the print unit 3. The printheads 30 discharge liquid ink to the transfer member (intermediate transfer member) 2 and form ink images of a printed image on the transfer member 2.

In this embodiment, each printhead 30 is a full-line head elongated in the Y direction, and nozzles are arrayed in a range where they cover the width of an image printing area of a print medium having a usable maximum size. Each printhead 30 has an ink discharge surface with the opened nozzle on its lower surface, and the ink discharge surface faces the surface of the transfer member 2 via a minute gap (for example, several mm). In this embodiment, the transfer member 2 is configured to move on a circular orbit cyclically, and thus the plurality of printheads 30 are arranged radially.

Each nozzle includes a discharge element. The discharge element is, for example, an element that generates a pressure in the nozzle and discharges ink in the nozzle, and the technique of an inkjet head in a well-known inkjet printer is applicable. For example, an element that discharges ink by causing film boiling in ink with an electrothermal transducer and forming a bubble, an element that discharges ink by an electromechanical transducer (piezoelectric element), an element that discharges ink by using static electricity, or the like can be given as the discharge element. A discharge element that uses the electrothermal transducer can be used from the viewpoint of high-speed and high-density printing.

In this embodiment, nine printheads 30 are provided. The respective printheads 30 discharge different kinds of inks. The different kinds of inks are, for example, different in coloring material and include yellow ink, magenta ink, cyan ink, black ink, and the like. One printhead 30 discharges one kind of ink. However, one printhead 30 may be configured to discharge the plurality of kinds of inks. When the plurality of printheads 30 are thus provided, some of them may discharge ink (for example, clear ink) that does not include a coloring material.

The carriage 31 supports the plurality of printheads 30. The end of each printhead 30 on the side of an ink discharge surface is fixed to the carriage 31. This makes it possible to maintain a gap on the surface between the ink discharge surface and the transfer member 2 more precisely. The carriage 31 is configured to be displaceable while mounting the printheads 30 by the guide of each guide member RL. In this embodiment, the guide members RL are rail members elongated in the Y direction and provided as a pair separately in the X direction. A slide portion 32 is provided on each side of the carriage 31 in the X direction. The slide portions 32 engage with the guide members RL and slide along the guide members RL in the Y direction.

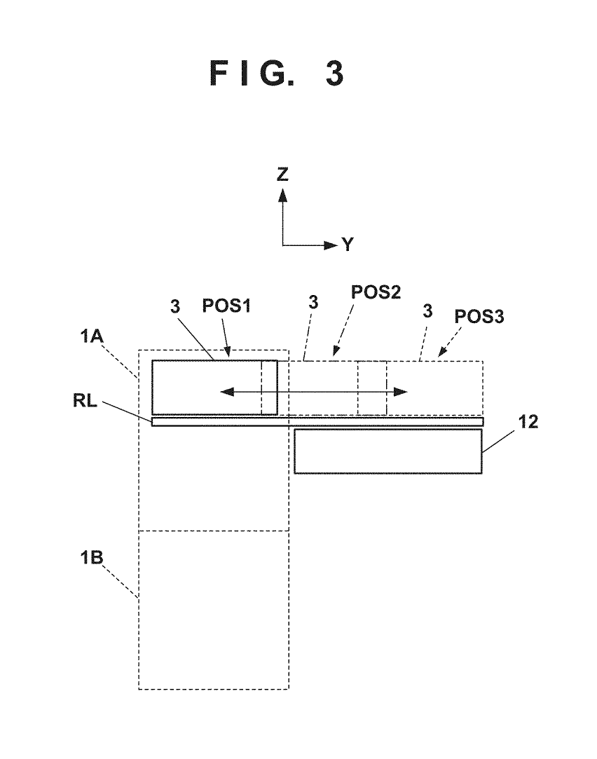

FIG. 3 is a view showing a displacement mode of the print unit 3 and schematically shows the right side surface of the printing system 1. A recovery unit 12 is provided in the rear of the printing system 1. The recovery unit 12 has a mechanism for recovering discharge performance of the printheads 30. For example, a cap mechanism which caps the ink discharge surface of each printhead 30, a wiper mechanism which wipes the ink discharge surface, a suction mechanism which sucks ink in the printhead 30 by a negative pressure from the ink discharge surface can be given as such mechanisms.

The guide member RL is elongated over the recovery unit 12 from the side of the transfer member 2. By the guide of the guide member RL, the print unit 3 is displaceable between a discharge position POS1 at which the print unit 3 is indicated by a solid line and a recovery position POS3 at which the print unit 3 is indicated by a broken line , and is moved by a driving mechanism (not shown).

The discharge position POS1 is a position at which the print unit 3 discharges ink to the transfer member 2 and a position at which the ink discharge surface of each printhead 30 faces the surface of the transfer member 2. The recovery position POS3 is a position retracted from the discharge position POS1 and a position at which the print unit 3 is positioned above the recovery unit 12. The recovery unit 12 can perform recovery processing on the printheads 30 when the print unit 3 is positioned at the recovery position POS3. In this embodiment, the recovery unit 12 can also perform the recovery processing in the middle of movement before the print unit 3 reaches the recovery position POS3. There is a preliminary recovery position POS2 between the discharge position POS1 and the recovery position POS3. The recovery unit 12 can perform preliminary recovery processing on the printheads 30 at the preliminary recovery position POS2 while the printheads 30 move from the discharge position POS1 to the recovery position POS3.

<Transfer Unit>

The transfer unit 4 will be described with reference to FIG. 1. The transfer unit 4 includes a transfer drum 41 and a pressurizing drum 42. Each of these drums is a rotating body that rotates about a rotation axis in the Y direction and has a columnar outer peripheral surface. In FIG. 1, arrows shown in respective views of the transfer drum 41 and the pressurizing drum 42 indicate their rotation directions. The transfer drum 41 rotates clockwise, and the pressurizing drum 42 rotates anticlockwise.

The transfer drum 41 is a support member that supports the transfer member 2 on its outer peripheral surface. The transfer member 2 is provided on the outer peripheral surface of the transfer drum 41 continuously or intermittently in a circumferential direction. If the transfer member 2 is provided continuously, it is formed into an endless swath. If the transfer member 2 is provided intermittently, it is formed into swaths with ends dividedly into a plurality of segments. The respective segments can be arranged in an arc at an equal pitch on the outer peripheral surface of the transfer drum 41.

The transfer member 2 moves cyclically on the circular orbit by rotating the transfer drum 41. By the rotational phase of the transfer drum 41, the position of the transfer member 2 can be discriminated into a processing area R1 before discharge, a discharge area R2, processing areas R3 and R4 after discharge, a transfer area R5, and a processing area R6 after transfer. The transfer member 2 passes through these areas cyclically.

The processing area R1 before discharge is an area where preprocessing is performed on the transfer member 2 before the print unit 3 discharges ink and an area where the peripheral unit 5A performs processing. In this embodiment, a reactive liquid is applied. The discharge area R2 is a formation area where the print unit 3 forms an ink image by discharging ink to the transfer member 2. The processing areas R3 and R4 after discharge are processing areas where processing is performed on the ink image after ink discharge. The processing area R3 after discharge is an area where the peripheral unit 5B performs processing, and the processing area R4 after discharge is an area where the peripheral unit 5C performs processing. The transfer area R5 is an area where the transfer unit 4 transfers the ink image on the transfer member 2 to the print medium P. The processing area R6 after transfer is an area where post processing is performed on the transfer member 2 after transfer and an area where the peripheral unit 5D performs processing.

In this embodiment, the discharge area R2 is an area with a predetermined section. The other areas R1 and R3 to R6 have narrower sections than the discharge area R2. Comparing to the face of a clock, in this embodiment, the processing area R1 before discharge is positioned at almost 10 o'clock, the discharge area R2 is in a range from almost 11 o'clock to 1 o'clock, the processing area R3 after discharge is positioned at almost 2 o'clock, and the processing area R4 after discharge is positioned at almost 4 o'clock. The transfer area R5 is positioned at almost 6 o'clock, and the processing area R6 after transfer is an area at almost 8 o'clock.

The transfer member 2 may be formed by a single layer but may be an accumulative body of a plurality of layers. If the transfer member 2 is formed by the plurality of layers, it may include three layers of, for example, a surface layer, an elastic layer, and a compressed layer. The surface layer is an outermost layer having an image formation surface where the ink image is formed. By providing the compressed layer, the compressed layer absorbs deformation and disperses a local pressure fluctuation, making it possible to maintain transferability even at the time of high-speed printing. The elastic layer is a layer between the surface layer and the compressed layer.

As a material for the surface layer, various materials such as a resin and a ceramic can be used appropriately. In respect of durability or the like, however, a material high in compressive modulus can be used. More specifically, an acrylic resin, an acrylic silicone resin, a fluoride-containing resin, a condensate obtained by condensing a hydrolyzable organosilicon compound, and the like can be given. The surface layer that has undergone a surface treatment may be used in order to improve wettability of the reactive liquid, the transferability of an image, or the like. Frame processing, a corona treatment, a plasma treatment, a polishing treatment, a roughing treatment, an active energy beam irradiation treatment, an ozone treatment, a surfactant treatment, a silane coupling treatment, or the like can be given as the surface treatment. A plurality of them may be combined. It is also possible to provide any desired surface shape in the surface layer.

For example, acrylonitrile-butadiene rubber, acrylic rubber, chloroprene rubber, urethane rubber, silicone rubber, or the like can be given as a material for the compressed layer. When such a rubber material is formed, a porous rubber material may be formed by blending a predetermined amount of a vulcanizing agent, vulcanizing accelerator, or the like and further blending a foaming agent, or a filling agent such as hollow fine particles or salt as needed. Consequently, a bubble portion is compressed along with a volume change with respect to various pressure fluctuations, and thus deformation in directions other than a compression direction is small, making it possible to obtain more stable transferability and durability. As the porous rubber material, there are a material having an open cell structure in which respective pores continue to each other and a material having a closed cell structure in which the respective pores are independent of each other. However, either structure may be used, or both of these structures may be used.

As a member for the elastic layer, the various materials such as the resin and the ceramic can be used appropriately. In respect of processing characteristics, various materials of an elastomer material and a rubber material can be used. More specifically, for example, fluorosilicone rubber, phenyl siliscone rubber, fluorine rubber, chloroprene rubber, urethane rubber, nitrile rubber, and the like can be given. In addition, ethylene propylene rubber, natural rubber, styrene rubber, isoprene rubber, butadiene rubber, the copolymer of ethylene/propylene/butadiene, nitrile-butadiene rubber, and the like can be given. In particular, silicone rubber, fluorosilicone rubber, and phenyl silicon rubber are advantageous in terms of dimensional stability and durability because of their small elasticity charge by a temperature.

Between the surface layer and the elastic layer and between the elastic layer and the compressed layer, various adhesives or double-sided adhesive tapes can also be used in order to fix them to each other. The transfer member 2 may also include a reinforce layer high in compressive modules in order to suppress elongation in a horizontal direction or maintain resilience when attached to the transfer drum 41. Woven fabric may be used as a reinforce layer. The transfer member 2 can be manufactured by combining the respective layers formed by the materials described above in any desired manner.

The outer peripheral surface of the pressurizing drum 42 is pressed against the transfer member 2. At least one grip mechanism which grips the leading edge portion of the print medium P is provided on the outer peripheral surface of the pressurizing drum 42. A plurality of grip mechanisms may be provided separately in the circumferential direction of the pressurizing drum 42. The ink image on the transfer member 2 is transferred to the print medium P when it passes through a nip portion between the pressurizing drum 42 and the transfer member 2 while being conveyed in tight contact with the outer peripheral surface of the pressurizing drum 42.

The transfer drum 41 and the pressurizing drum 42 share a driving source such as a motor that drives them. A driving force can be delivered by a transmission mechanism such as a gear mechanism.

<Peripheral Unit>

The peripheral units 5A to 5D are arranged around the transfer drum 41. In this embodiment, the peripheral units 5A to 5D are specifically an application unit, an absorption unit, a heating unit, and a cleaning unit in order.

The application unit 5A is a mechanism which applies the reactive liquid onto the transfer member 2 before the print unit 3 discharges ink. The reactive liquid is a liquid that contains a component increasing an ink viscosity. An increase in ink viscosity here means that a coloring material, a resin, and the like that form the ink react chemically or suck physically by contacting the component that increases the ink viscosity, recognizing the increase in ink viscosity. This increase in ink viscosity includes not only a case in which an increase in viscosity of entire ink is recognized but also a case in which a local increase in viscosity is generated by coagulating some of components such as the coloring material and the resin that form the ink.

The component that increases the ink viscosity can use, without particular limitation, a substance such as metal ions or a polymeric coagulant that causes a pH change in ink and coagulates the coloring material in the ink, and can use an organic acid. For example, a roller, a printhead, a die coating apparatus (die coater), a blade coating apparatus (blade coater), or the like can be given as a mechanism which applies the reactive liquid. If the reactive liquid is applied to the transfer member 2 before the ink is discharged to the transfer member 2, it is possible to immediately fix ink that reaches the transfer member 2. This makes it possible to suppress bleeding caused by mixing adjacent inks.

The absorption unit 5B is a mechanism which absorbs a liquid component from the ink image on the transfer member 2 before transfer. It is possible to suppress, for example, a blur of an image printed on the print medium P by decreasing the liquid component of the ink image. Describing a decrease in liquid component from another point of view, it is also possible to represent it as condensing ink that forms the ink image on the transfer member 2. Condensing the ink means increasing the content of a solid content such as a coloring material or a resin included in the ink with respect to the liquid component by decreasing the liquid component included in the ink.

The absorption unit 5B includes, for example, a liquid absorbing member that decreases the amount of the liquid component of the ink image by contacting the ink image. The liquid absorbing member may be formed on the outer peripheral surface of the roller or may be formed into an endless sheet-like shape and run cyclically. In terms of protection of the ink image, the liquid absorbing member may be moved in synchronism with the transfer member 2 by making the moving speed of the liquid absorbing member equal to the peripheral speed of the transfer member 2.

The liquid absorbing member may include a porous body that contacts the ink image. The pore size of the porous body on the surface that contacts the ink image may be equal to or smaller than 10 μm in order to suppress adherence of an ink solid content to the liquid absorbing member. The pore size here refers to an average diameter and can be measured by a known means such as a mercury intrusion technique, a nitrogen adsorption method, an SEM image observation, or the like. Note that the liquid component does not have a fixed shape, and is not particularly limited if it has fluidity and an almost constant volume. For example, water, an organic solvent, or the like contained in the ink or reactive liquid can be given as the liquid component.

The heating unit 5C is a mechanism which heats the ink image on the transfer member 2 before transfer. A resin in the ink image melts by heating the ink image, improving transferability to the print medium P. A heating temperature can be equal to or higher than the minimum film forming temperature (MFT) of the resin. The MFT can be measured by each apparatus that complies with a generally known method such as JIS K 6828-2: 2003 or ISO 2115: 1996. From the viewpoint of transferability and image robustness, the ink image may be heated at a temperature higher than the MFT by 10° C. or higher, or may further be heated at a temperature higher than the MFT by 20° C. or higher. The heating unit 5C can use a known heating device, for example, various lamps such as infrared rays, a warm air fan, or the like. An infrared heater can be used in terms of heating efficiency.

The cleaning unit 5D is a mechanism which cleans the transfer member 2 after transfer. The cleaning unit 5D removes ink remaining on the transfer member 2, dust on the transfer member 2, or the like. The cleaning unit 5D can use a known method, for example, a method of bringing a porous member into contact with the transfer member 2, a method of scraping the surface of the transfer member 2 with a brush, a method of scratching the surface of the transfer member 2 with a blade, or the like as needed. A known shape such as a roller shape or a web shape can be used for a cleaning member used for cleaning.

As described above, in this embodiment, the application unit 5A, the absorption unit 5B, the heating unit 5C, and the cleaning unit 5D are included as the peripheral units. However, cooling functions of the transfer member 2 may be applied, or cooling units may be added to these units. In this embodiment, the temperature of the transfer member 2 may be increased by heat of the heating unit 5C. If the ink image exceeds the boiling point of water as a prime solvent of ink after the print unit 3 discharges ink to the transfer member 2, performance of liquid component absorption by the absorption unit 5B may be degraded. It is possible to maintain the performance of liquid component absorption by cooling the transfer member 2 such that the temperature of the discharged ink is maintained below the boiling point of water.

The cooling unit may be an air blowing mechanism which blows air to the transfer member 2, or a mechanism which brings a member (for example, a roller) into contact with the transfer member 2 and cools this member by air-cooling or water-cooling. The cooling unit may be a mechanism which cools the cleaning member of the cleaning unit 5D. A cooling timing may be a period before application of the reactive liquid after transfer.

<Supply Unit>

The supply unit 6 is a mechanism which supplies ink to each printhead 30 of the print unit 3. The supply unit 6 may be provided on the rear side of the printing system 1. The supply unit 6 includes a reservoir TK that reserves ink for each kind of ink. Each reservoir TK may be made of a main tank and a sub tank. Each reservoir TK and a corresponding one of the printheads 30 communicate with each other by a liquid passageway 6a, and ink is supplied from the reservoir TK to the printhead 30. The liquid passageway 6a may circulate ink between the reservoirs TK and the printheads 30. The supply unit 6 may include, for example, a pump that circulates ink. A deaerating mechanism which deaerates bubbles in ink may be provided in the middle of the liquid passageway 6a or in each reservoir TK. A valve that adjusts the fluid pressure of ink and an atmospheric pressure may be provided in the middle of the liquid passageway 6a or in each reservoir TK. The heights of each reservoir TK and each printhead 30 in the Z direction may be designed such that the liquid surface of ink in the reservoir TK is positioned lower than the ink discharge surface of the printhead 30.

<Conveyance Apparatus>

The conveyance apparatus 1B is an apparatus that feeds the print medium P to the transfer unit 4 and discharges, from the transfer unit 4, the printed product P′ to which the ink image was transferred. The conveyance apparatus 1B includes a feeding unit 7, a plurality of conveyance drums 8 and 8a, two sprockets 8b, a chain 8c, and a collection unit 8d. In FIG. 1, an arrow inside a view of each constituent element in the conveyance apparatus 1B indicates a rotation direction of the constituent element, and an arrow outside the view of each constituent element indicates a conveyance path of the print medium P or the printed product P′. The print medium P is conveyed from the feeding unit 7 to the transfer unit 4, and the printed product P′ is conveyed from the transfer unit 4 to the collection unit 8d. The side of the feeding unit 7 may be referred to as an upstream side in a conveyance direction, and the side of the collection unit 8d may be referred to as a downstream side.

The feeding unit 7 includes a stacking unit where the plurality of print media P are stacked and a feeding mechanism which feeds the print media P one by one from the stacking unit to the most upstream conveyance drum 8. Each of the conveyance drums 8 and 8a is a rotating body that rotates about the rotation axis in the Y direction and has a columnar outer peripheral surface. At least one grip mechanism which grips the leading edge portion of the print medium P (printed product P′) is provided on the outer peripheral surface of each of the conveyance drums 8 and 8a. A gripping operation and release operation of each grip mechanism may be controlled such that the print medium P is transferred between the adjacent conveyance drums.

The two conveyance drums 8a are used to reverse the print medium P. When the print medium P undergoes double-side printing, it is not transferred to the conveyance drum 8 adjacent on the downstream side but transferred to the conveyance drums 8a from the pressurizing drum 42 after transfer onto the surface. The print medium P is reversed via the two conveyance drums 8a and transferred to the pressurizing drum 42 again via the conveyance drums 8 on the upstream side of the pressurizing drum 42. Consequently, the reverse surface of the print medium P faces the transfer drum 41, transferring the ink image to the reverse surface.

The chain 8c is wound between the two sprockets 8b. One of the two sprockets 8b is a driving sprocket, and the other is a driven sprocket. The chain 8c runs cyclically by rotating the driving sprocket. The chain 8c includes a plurality of grip mechanisms spaced apart from each other in its longitudinal direction. Each grip mechanism grips the end of the printed product P′. The printed product P′ is transferred from the conveyance drum 8 positioned at a downstream end to each grip mechanism of the chain 8c, and the printed product P′ gripped by the grip mechanism is conveyed to the collection unit 8d by running the chain 8c, releasing gripping. Consequently, the printed product P′ is stacked in the collection unit 8d.

<Post Processing Unit>

The conveyance apparatus 1B includes post processing units 10A and 10B. The post processing units 10A and 10B are mechanisms which are arranged on the downstream side of the transfer unit 4, and perform post processing on the printed product P′. The post processing unit 10A performs processing on the obverse surface of the printed product P′, and the post processing unit 10B performs processing on the reverse surface of the printed product P′. The contents of the post processing includes, for example, coating that aims at protection, glossy, and the like of an image on the image printed surface of the printed product P′. For example, liquid application, sheet welding, lamination, and the like can be given as an example of coating.

<Inspection Unit>

The conveyance apparatus 1B includes inspection units 9A and 9B. The inspection units 9A and 9B are mechanisms which are arranged on the downstream side of the transfer unit 4, and inspect the printed product P′.

In this embodiment, the inspection unit 9A is an image capturing apparatus that captures an image printed on the printed product P′ and includes an image sensor, for example, a CCD sensor, a CMOS sensor, or the like. The inspection unit 9A captures a printed image while a printing operation is performed continuously. Based on the image captured by the inspection unit 9A, it is possible to confirm a temporal change in tint or the like of the printed image and determine whether to correct image data or print data. In this embodiment, the inspection unit 9A has an imaging range set on the outer peripheral surface of the pressurizing drum 42 and is arranged to be able to partially capture the printed image immediately after transfer. The inspection unit 9A may inspect all printed images or may inspect the images every predetermined sheets.

In this embodiment, the inspection unit 9B is also an image capturing apparatus that captures an image printed on the printed product P′ and includes an image sensor, for example, a CCD sensor, a CMOS sensor, or the like. The inspection unit 9B captures a printed image in a test printing operation. The inspection unit 9B can capture the entire printed image. Based on the image captured by the inspection unit 9B, it is possible to perform basic settings for various correction operations regarding print data. In this embodiment, the inspection unit 9B is arranged at a position to capture the printed product P′ conveyed by the chain 8c. When the inspection unit 9B captures the printed image, it captures the entire image by temporarily suspending the run of the chain 8c. The inspection unit 9B may be a scanner that scans the printed product P′.

<Control Unit>

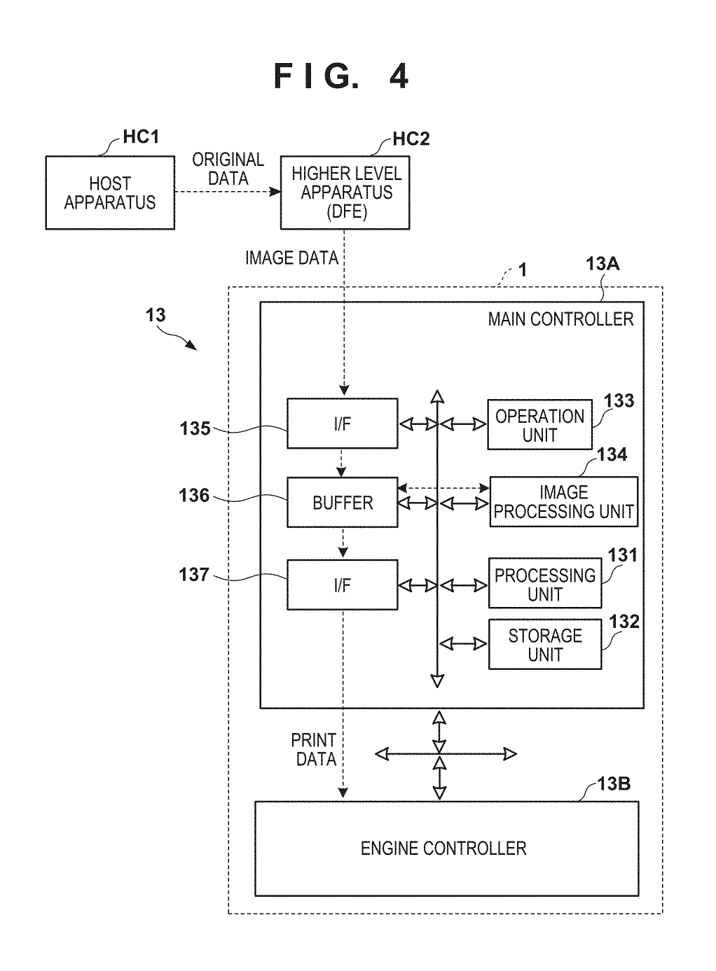

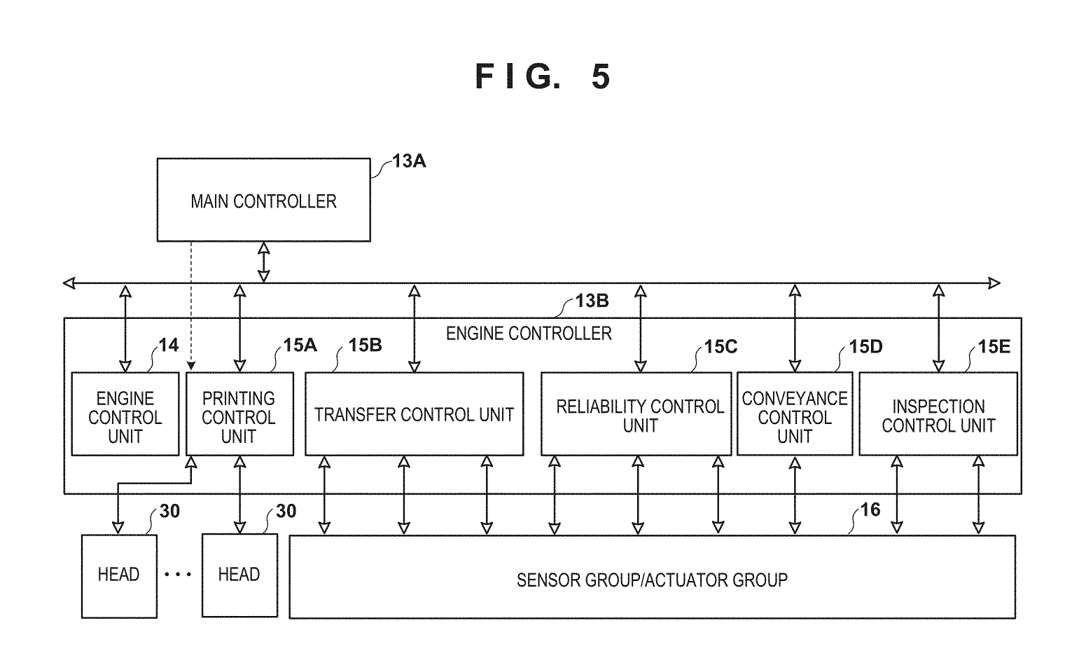

A control unit of the printing system 1 will be described next. FIGS. 4 and 5 are block diagrams each showing a control unit 13 of the printing system 1.

The control unit 13 is communicably connected to a higher level apparatus (DFE) HC2, and the higher level apparatus HC2 is communicably connected to a host apparatus HC1.

The host apparatus HC1 may be, for example, a PC (Personal Computer) serving as an information processing apparatus, or a server apparatus. A communication method between the host apparatus HC1 and the higher level apparatus HC2 may be, without particular limitation, either wired or wireless communication.

Original data to be the source of a printed image is generated or saved in the host apparatus HC1. The original data here is generated in the format of, for example, an electronic file such as a document file or an image file. This original data is transmitted to the higher level apparatus HC2. In the higher level apparatus HC2, the received original data is converted into a data format (for example, RGB data that represents an image by RGB) available by the control unit 13. The converted data is transmitted from the higher level apparatus HC2 to the control unit 13 as image data. The control unit 13 starts a printing operation based on the received image data.

In this embodiment, the control unit 13 is roughly divided into a main controller 13A and an engine controller 13B. The main controller 13A includes a processing unit 131, a storage unit 132, an operation unit 133, an image processing unit 134, a communication I/F (interface) 135, a buffer 136, and a communication I/F 137.

The processing unit 131 is a processor such as a CPU, executes programs stored in the storage unit 132, and controls the entire main controller 13A. The storage unit 132 is a storage device such as a RAM, a ROM, a hard disk, or an SSD, stores data and the programs executed by the processing unit (CPU) 131, and provides the processing unit (CPU) 131 with a work area. An external storage unit may further be provided in addition to the storage unit 132. The operation unit 133 is, for example, an input device such as a touch panel, a keyboard, or a mouse and accepts a user instruction. The operation unit 133 may be formed by an input unit and a display unit integrated with each other. Note that a user operation is not limited to an input via the operation unit 133, and an arrangement may be possible in which, for example, an instruction is accepted from the host apparatus HC1 or the higher level apparatus HC2.

The image processing unit 134 is, for example, an electronic circuit including an image processing processor. The buffer 136 is, for example, a RAM, a hard disk, or an SSD. The communication I/F 135 communicates with the higher level apparatus HC2, and the communication I/F 137 communicates with the engine controller 13B. In FIG. 4, broken-line arrows exemplify the processing sequence of image data. Image data received from the higher level apparatus HC2 via the communication I/F 135 is accumulated in the buffer 136. The image processing unit 134 reads out the image data from the buffer 136, performs predetermined image processing on the readout image data, and stores the processed data in the buffer 136 again. The image data after the image processing stored in the buffer 136 is transmitted from the communication I/F 137 to the engine controller 13B as print data used by a print engine.

As shown in FIG. 5, the engine controller 13B includes an engine control units 14 and 15A to 15E, and obtains a detection result of a sensor group/actuator group 16 of the printing system 1 and controls driving of the groups. Each of these control units includes a processor such as a CPU, a storage device such as a RAM or a ROM, and an interface with an external device. Note that the division of the control units is merely illustrative, and a plurality of subdivided control units may perform some of control operations or conversely, the plurality of control units may be integrated with each other, and one control unit may be configured to implement their control contents.

The engine control unit 14 controls the entire engine controller 13B. The printing control unit 15A converts print data received from the main controller 13A into raster data or the like in a data format suitable for driving of the printheads 30. The printing control unit 15A controls discharge of each printhead 30.

The transfer control unit 15B controls the application unit 5A, the absorption unit 5B, the heating unit 5C, and the cleaning unit 5D.

The reliability control unit 15C controls the supply unit 6, the recovery unit 12, and a driving mechanism which moves the print unit 3 between the discharge position POS1 and the recovery position POS3.

The conveyance control unit 15D controls driving of the transfer unit 4 and controls the conveyance apparatus 1B. The inspection control unit 15E controls the inspection unit 9B and the inspection unit 9A.

Of the sensor group/actuator group 16, the sensor group includes a sensor that detects the position and speed of a movable part, a sensor that detects a temperature, an image sensor, and the like. The actuator group includes a motor, an electromagnetic solenoid, an electromagnetic valve, and the like.

<Operation Example>

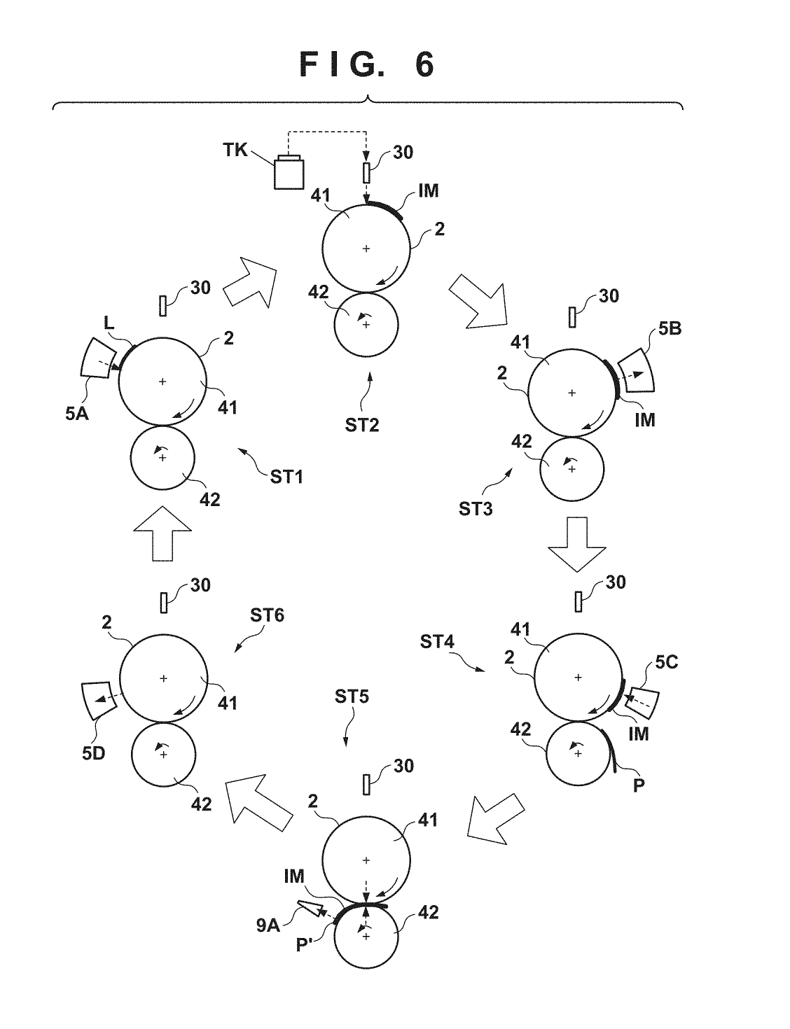

FIG. 6 is a view schematically showing an example of a printing operation. Respective steps below are performed cyclically while rotating the transfer drum 41 and the pressurizing drum 42. As shown in a state ST1, first, a reactive liquid L is applied from the application unit 5A onto the transfer member 2. A portion to which the reactive liquid L on the transfer member 2 is applied moves along with the rotation of the transfer drum 41. When the portion to which the reactive liquid L is applied reaches under the printhead 30, ink is discharged from the printhead 30 to the transfer member 2 as shown in a state ST2. Consequently, an ink image IM is formed. At this time, the discharged ink mixes with the reactive liquid L on the transfer member 2, promoting coagulation of the coloring materials. The discharged ink is supplied from the reservoir TK of the supply unit 6 to the printhead 30.

The ink image IM on the transfer member 2 moves along with the rotation of the transfer member 2. When the ink image IM reaches the absorption unit 5B, as shown in a state ST3, the absorption unit 5B absorbs a liquid component from the ink image IM. When the ink image IM reaches the heating unit 5C, as shown in a state ST4, the heating unit 5C heats the ink image IM, a resin in the ink image IM melts, and a film of the ink image IM is formed. In synchronism with such formation of the ink image IM, the conveyance apparatus 1B conveys the print medium P.

As shown in a state ST5, the ink image IM and the print medium P reach the nip portion between the transfer member 2 and the pressurizing drum 42, the ink image IM is transferred to the print medium P, and the printed product P′ is formed. Passing through the nip portion, the inspection unit 9A captures an image printed on the printed product P′ and inspects the printed image. The conveyance apparatus 1B conveys the printed product P′ to the collection unit 8d.

When a portion where the ink image IM on the transfer member 2 is formed reaches the cleaning unit 5D, it is cleaned by the cleaning unit 5D as shown in a state ST6. After the cleaning, the transfer member 2 rotates once, and transfer of the ink image to the print medium P is performed repeatedly in the same procedure. The description above has been given such that transfer of the ink image IM to one print medium P is performed once in one rotation of the transfer member 2 for the sake of easy understanding. It is possible, however, to continuously perform transfer of the ink image IM to the plurality of print media P in one rotation of the transfer member 2.

Each printhead 30 needs maintenance if such a printing operation continues.

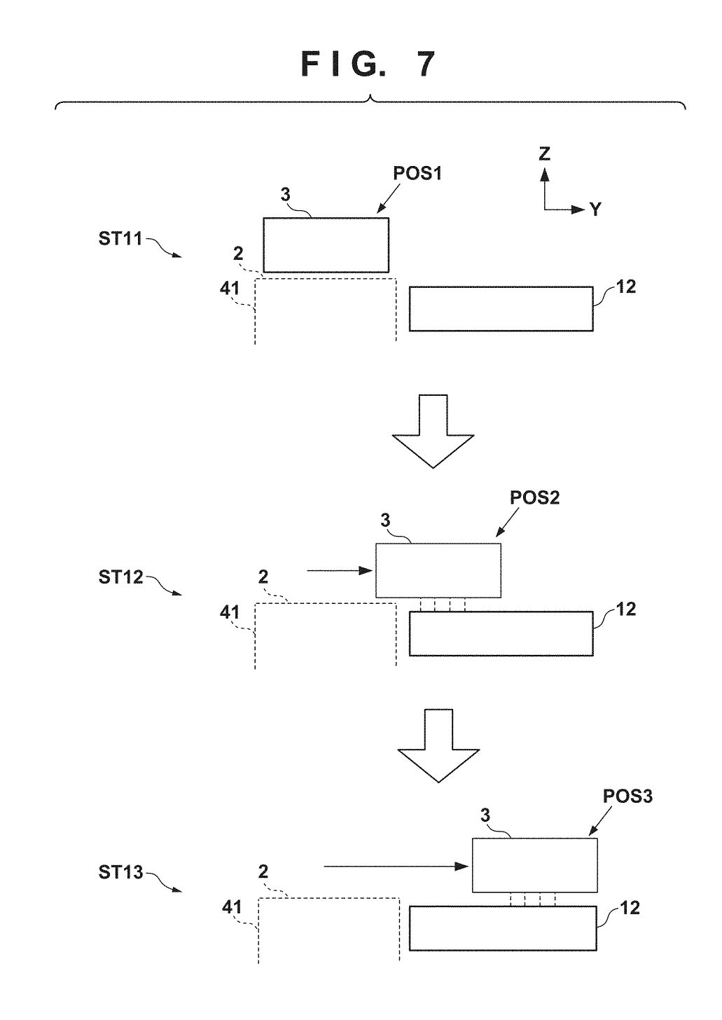

FIG. 7 shows an operation example at the time of maintenance of each printhead 30. A state ST11 shows a state in which the print unit 3 is positioned at the discharge position POS1. A state ST12 shows a state in which the print unit 3 passes through the preliminary recovery position POS2. Under passage, the recovery unit 12 performs a process of recovering discharge performance of each printhead 30 of the print unit 3. Subsequently, as shown in a state ST13, the recovery unit 12 performs the process of recovering the discharge performance of each printhead 30 in a state in which the print unit 3 is positioned at the recovery position POS3.

A cleaning operation performed by the cleaning unit 5D arranged around a transfer member in the printing system having the above arrangement will be described next.

<Detailed Description of Transfer Member and Pressurizing Drum>

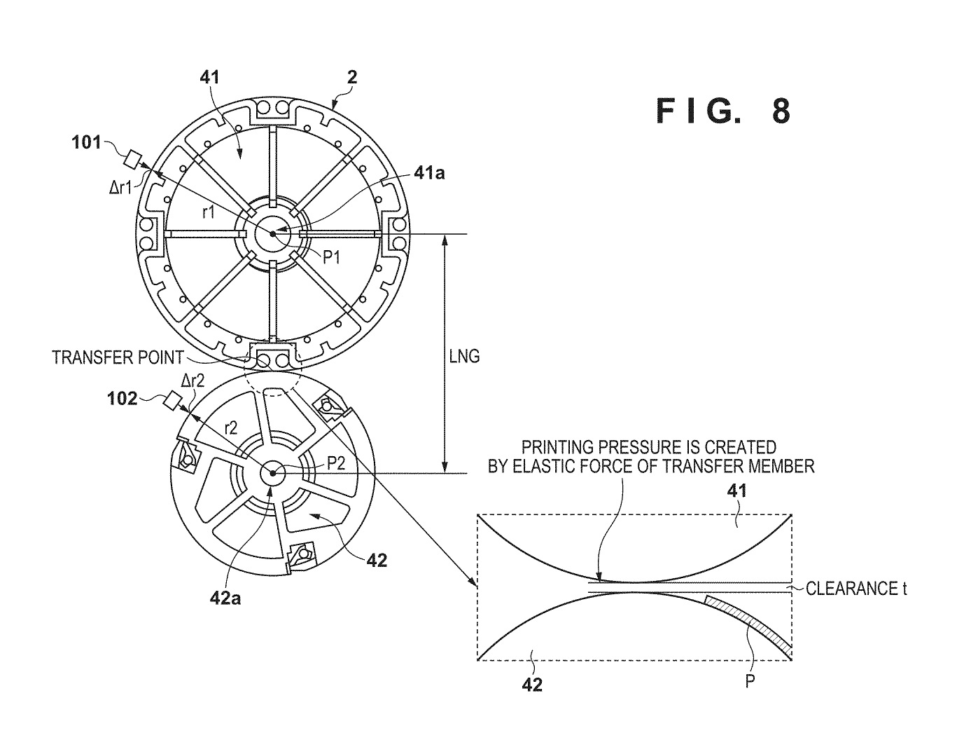

FIG. 8 is a view showing the detailed arrangements of the transfer member and the pressurizing drum, and a positional relationship between the two.

As shown in FIG. 8, the transfer member 2 is supported by the transfer drum 41 and provided on the outer periphery of the transfer drum 41. In this embodiment, regardless of whether the transfer member 2 is formed by a single layer or formed by an accumulative body of multiple layers, it has elasticity like rubber and when it nips the print medium P with the pressurizing drum 42, a printing pressure is created on the print medium P by an elastic force. Then, the transfer member 2 rotates clockwise about a rotating shaft 41a with a position P1 as the center. On the other hand, the pressurizing drum 42 provided facing the transfer member 2 rotates anticlockwise about a rotating shaft 42a with a position P2 as the center.

As indicated by a thick dotted line in FIG. 8, a nip portion is formed by the pressurizing drum 42 and the transfer drum 41 where the transfer member 2 is provided, the print medium P is nipped by this nip portion, and an image formed on the transfer member 2 is transferred to the print medium P.

The transfer drum 41 where the transfer member 2 is provided is a columnar drum having a radius rl, and the pressurizing drum 42 is a columnar drum having a radius r2. A distance between the transfer drum 41 and the pressurizing drum 42 is defined as an axis-to-axis distance between the center positions (axes) P1 and P2 of the respective rotating shafts. FIG. 8 shows this distance as an LNG. The axis-to-axis distance LNG is adjustable by, for example, an axis-to-axis distance adjustment mechanism (to be described later) using an eccentric bearing or the like. The rotating shaft 41a is rotatably fixed to this axis-to-axis distance adjustment mechanism. The rotating shaft 42a is rotatably fixed to a frame of the conveyance apparatus 1B. Therefore, in this embodiment, the axis-to-axis distance adjustment mechanism changes the position of the rotating shaft 41a, adjusting the axis-to-axis distance LNG.

A laser sensor 101 is provided at a position slightly apart from the outer surface of the transfer member 2, and the transfer member 2 is irradiated with a laser beam from the laser sensor 101 in a normal direction, making it possible to detect a change amount (Δr1) of the radius r1 in submicrons. On the other hand, a laser sensor 102 is provided at a position slightly apart from the outer surface of the pressurizing drum 42, and the pressurizing drum 42 is irradiated with a laser beam from the laser sensor 102 in a normal direction, making it possible to detect a change amount (Δr2) of the radius r2 in submicrons. A value detected by the initial measurement is set to an initial value here.

Note that sensors other than the laser sensors may be used for sensors configured to detect changes in the radii r1 and r2. For example, it is also possible to measure the temperatures of the transfer member 2 and the pressurizing drum 42 by using infrared sensors, and calculate the changes in the radii r1 and r2 from the temperatures and the rates of thermal expansion of the transfer member 2 and the pressurizing drum 42.

In a region surrounded by a dotted line on the right side of FIG. 8, an enlarged view of the nip portion by the transfer drum 41 and the pressurizing drum 42 is shown. A state in which the pressurizing drum 42 conveys the print medium P is shown here. In reality, there is a clearance t between the transfer drum 41 and the pressurizing drum 42. If a thickness d of the print medium P is larger than the clearance t (d>t), the transfer member 2 provided in the transfer drum 41 is deformed by its elasticity, creating a printing pressure (transfer pressure) on the print medium P along with conveyance of the print medium P.

Therefore, the clearance t changes if, for example, the transfer drum 41 and the pressurizing drum 42 undergo thermal expansion (or compression) owing to a temperature increase of the printing system 1 or the like by operating the heating unit 5C. This change in the clearance t changes the printing pressure (transfer pressure).

Thus, in this embodiment, the transfer member 2 and the pressurizing drum 42 are, respectively, irradiated with the laser beams from the two laser sensors 101 and 102 at a predetermined time interval, measuring displacements in the radii r1 and r2. A change amount (clearance change amount) At of the clearance t is represented by a sum (Δr1+Δr2) of the change amount (Δr1) of the radius r1 and the change amount (Δr2) of the radius r2. Then, the change amount Δt is compared with a predetermined threshold (TH) and if the change amount exceeds the threshold, the axis-to-axis distance adjustment mechanism is operated to control such that the clearance t falls within a predetermined range.

Note that the thickness d of the print medium P changes depending on its type, and thus it is desirable that the appropriate clearance t is set in accordance with the type of the print medium P. For this purpose, it is preferable that a user of the printing system 1 sets, for example, the value of the thickness d or the type of the print medium P from the operation unit 133.

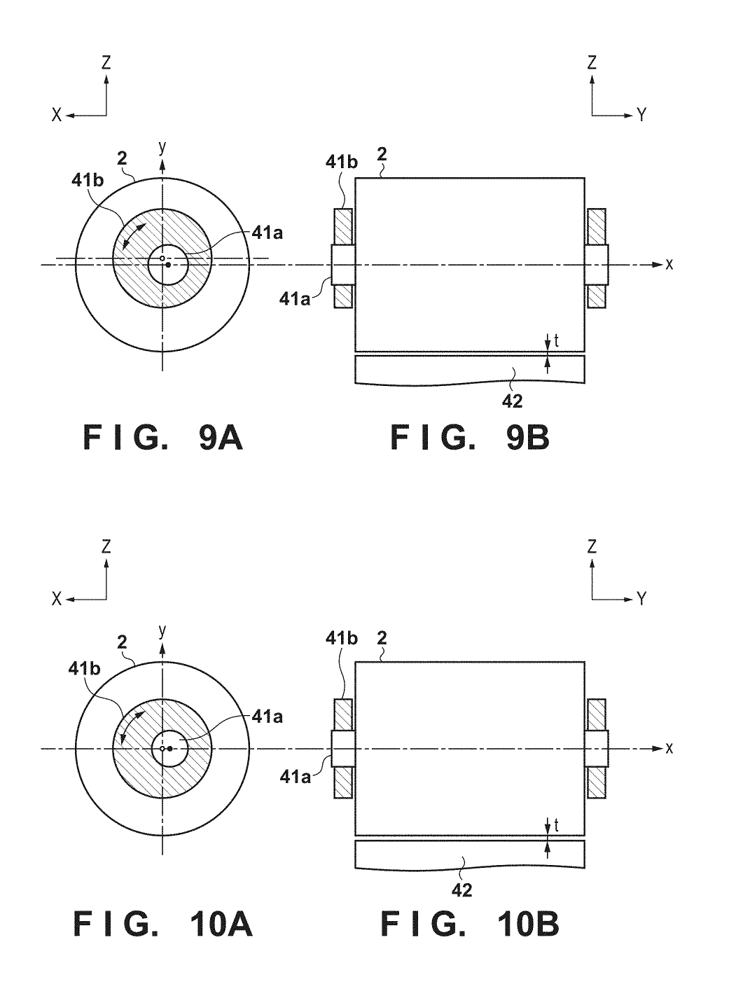

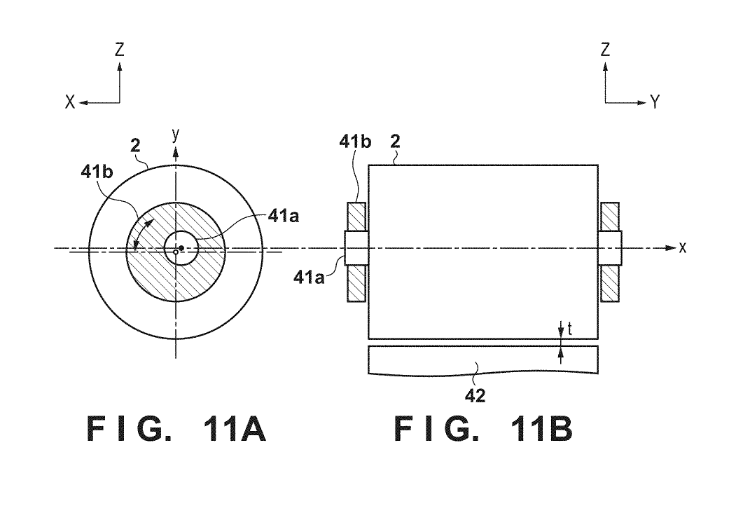

FIGS. 9A to 11B are views each showing the outline of the axis-to-axis distance adjustment mechanism. A state is shown in which the clearance t shown in FIG. 9B is the smallest among FIGS. 9B, 10B, and 11B, and then the clearance t becomes larger by the axis-to-axis distance adjustment mechanism in FIGS. 10B and 11B. The axis-to-axis distance adjustment mechanism in this embodiment is formed by a shaft support part 41b serving as a columnar eccentric bearing.

Each of FIGS. 9A, 10A, and 11A is a view showing the transfer member 2 from the Y direction and a view showing a relative positional relationship between the rotating shaft 41a and the shaft support part 41b. Each of FIGS. 9B, 10B, and 11B is a view showing the transfer drum 41 and the pressurizing drum 42 from the X direction, and a view showing a relative positional relationship between the transfer drum 41 and the pressurizing drum 42. FIGS. 9A and 9B correspond with each other, and the positional relationship between the transfer drum 41 and the pressurizing drum 42 shown in FIG. 9B holds when the positional relationship between the rotating shaft 41a and the shaft support part 41b shown in FIG. 9A is obtained. The same also applies to FIGS. 10A and 10B, and FIGS. 11A and 11B.

As shown in FIGS. 9A, 10A, and 11A, the columnar shaft support part 41b is structured to be decentered from the rotation center of the rotating shaft 41a indicated by a full circular point ● and support the rotating shaft 41a. When the shaft support part 41b rotates, a relative positional relationship between the rotation center (open circular point ◯) of the shaft support part 41b and the center position P1 of the rotating shaft 41a changes. Therefore, when the shaft support part 41b rotates, the rotating shaft 41a moves in the vertical (z) direction in accordance with the degree of its decentering. The axis-to-axis distance LNG between the transfer drum 41 and the pressurizing drum 42 is changed in accordance with movement of the rotating shaft 41a, and the clearance t changes accordingly.

The axis-to-axis distance LNG can be adjusted by thus rotating the shaft support part 41b acting as the axis-to-axis distance adjustment mechanism. With this rotation, it is possible to create a plurality of states different in clearance t as shown in FIGS. 9A to 11B. In FIG. 9A, the rotation center (open circular point ●) of the shaft support part 41b is located at a position higher than the center position P1 of the rotating shaft 41a in the vertical direction. In FIG. 10A, the rotation center (open circular point ●) of the shaft support part 41b and the center position P1 of the rotating shaft 41a are located at almost the same height in the vertical direction. In FIG. 11A, the rotation center (open circular point ●) of the shaft support part 41b is located at a position lower than the center position P1 of the rotating shaft 41a in the vertical direction. In accordance with these positional relationships, the clearance t is the smallest in FIG. 9B and the largest in FIG. 11B.

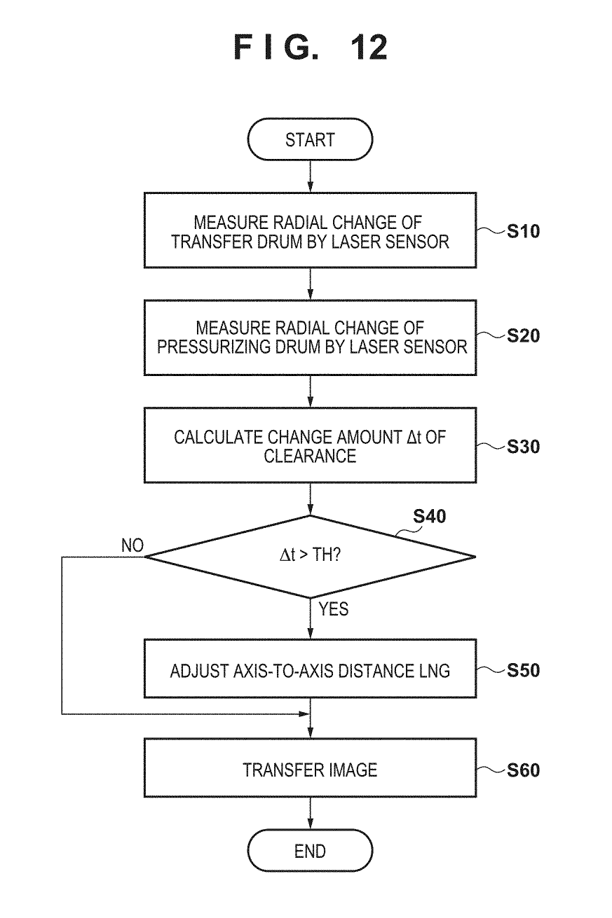

FIG. 12 is a flowchart showing axis-to-axis distance adjustment processing according to this embodiment.

FIG. 12 shows basic processing steps. According to FIG. 12, first, in step S10, the transfer member 2 is irradiated with a laser beam from the laser sensor 101 in a radial direction, measuring the change (Δr1) in radius rl. Next, in step S20, the pressurizing drum 42 is irradiated with a laser beam from the laser sensor 102 in a radial direction, measuring the change (Δr2) in radius r2.

In step S30, the change amount At of the clearance t is calculated from the measured change amount (Δr1) of the radius r1 and change amount (Δr2) of the radius r2. Then, in step S40, the change amount Δt is compared with the predetermined threshold (TH). Here, if Δt>TH, the process advances to step S50 in which control is performed such that the axis-to-axis distance LNG falls within a predetermined range, that is, the clearance t falls within a predetermined range by operating the axis-to-axis distance adjustment mechanism to pivot the shaft support part 41b. In contrast, if Δt≤TH, this process advances to step S60 without operating the axis-to-axis distance adjustment mechanism.

In step S60, an image is transferred to a print medium after the clearance t is adjusted by the axis-to-axis distance adjustment mechanism, or the clearance t is inspected and confirmed that it falls within the predetermined range. Subsequently, the process ends.

Note that in this embodiment, the change amounts of the radii r1 and r2 are measured by irradiating the transfer member2 and the pressurizing drum 42, respectively, with the laser beams from the two laser sensors 101 and 102 at a predetermined time interval. Thus, the above process is performed at the predetermined time interval.

Note that in step S40, when the change amount At is compared with the predetermined threshold (TH), n change amounts may be obtained by performing measurement n times with the laser sensors 101 and 102, an average value may be calculated, and the average value may be set as a change amount to be compared. This makes it possible to decrease a measurement error included for each measurement operation and obtain a more precise change amount. In this case, measurement is performed n times in each of steps S10 and S20, and in step S30, the change amount Δt is calculated after an average value for each of the measured n change amounts (Δr1) of the radius r1 and n change amounts (Δr2) of the radius r2 is calculated.

The laser sensors 101 and 102 further include infrared temperature sensors in their respective proximities. These sensors monitor the surface temperatures of the transfer member 2 and the pressurizing drum 42, and calculate their temperature changes. Then, when the temperature changes exceed the predetermined threshold, it may be determined that the change amount Δt of the clearance t is predicted to be larger, and axis-to-axis distance adjustment may be made by performing the above-described process.

Furthermore, a strain gauge may be attached to a frame to which the transfer drum 41 including the transfer member 2 is attached, a distortion caused in the frame may be calculated by an output from the strain gauge, and the change amount At may be corrected by the calculated distortion. Alternatively, a temperature sensor may be attached to the frame, a distortion caused in the frame may be calculated by an output from a detected temperature, and the change amount Δt may be corrected by the calculated distortion.

Note that sensors other than the laser sensors may be used for sensors configured to detect changes in the radii r1 and r2. For example, it is also possible to measure the surface temperatures of the transfer member 2 and the pressurizing drum 42 by using infrared temperature sensors, and calculate the change amounts of the radii r1 and r2 from the temperatures and the rates of thermal expansion of the transfer member 2 and the pressurizing drum 42.

Therefore, according to the above-described embodiment, a transfer pressure on the print medium is adjusted to be an appropriate pressure by adjusting a clearance between a transfer drum and the pressurizing drum. Consequently, an image is transferred from the transfer member to the print medium appropriately, printing a high-quality image.

In the above embodiment, the print unit 3 includes the plurality of printheads 30. However, a print unit 3 may include one printhead 30. The printhead 30 may not be a full-line head but may be of a serial type that forms an ink image while scanning the printhead 30 in a Y direction.

A conveyance mechanism of the print medium P may adopt another method such as a method of clipping and conveying the print medium P by the pair of rollers. In the method of conveying the print medium P by the pair of rollers or the like, a roll sheet may be used as the print medium P, and a printed product P′ may be formed by cutting the roll sheet after transfer.

In the above embodiment, the transfer member 2 is provided on the outer peripheral surface of the transfer drum 41. However, another method such as a method of forming a transfer member 2 into an endless swath and running it cyclically may be used.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)T′″), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-044225, filed Mar. 8, 2017, which is hereby incorporated by reference herein in its entirety.

What is claimed is:

1. A printing apparatus comprising:
a first rotating body on which an image is formed by a printhead;
a second rotating body configured to convey a print medium;
an obtaining unit configured to obtain a clearance between the first rotating body and the second rotating body;
an adjustment unit configured to adjust an axis-to-axis distance between a rotating shaft of the first rotating body and a rotating shaft of the second rotating body based on the clearance obtained by the obtaining unit; and
a transfer unit configured to transfer the image formed on the first rotating body to the print medium conveyed by the second rotating body and print the image.

2. The apparatus according to claim 1, further comprising a comparison unit configured to compare the clearance obtained by the obtaining unit with a predetermined threshold,
wherein the adjustment unit adjusts the axis-to-axis distance if a change in the clearance exceeds the predetermined threshold as a result of comparison by the comparison unit.

3. The apparatus according to claim 1, wherein the obtaining unit includes:
a first measurement unit configured to measure a diameter of the first rotating body;
a second measurement unit configured to measure a diameter of the second rotating body; and
a calculation unit configured to calculate the clearance based on the diameter of the first rotating body measured by the first measurement unit and the diameter of the second rotating body measured by the second measurement unit.

4. The apparatus according to claim 3, wherein the first measurement unit measures a first change amount from an initial value of the diameter of the first rotating body,
the second measurement unit measures a second change amount from an initial value of the diameter of the second rotating body, and
the calculation unit calculates a clearance change amount of the clearance based on the first change amount measured by the first measurement unit and the second change amount measured by the second measurement unit.

5. The apparatus according to claim 4, wherein the first measurement unit is a laser sensor configured to emit a laser beam in a radial direction of the first rotating body, and
the second measurement unit is a laser sensor configured to emit a laser beam in a radial direction of the second rotating body.

6. The apparatus according to claim 4, wherein the first measurement unit is a temperature sensor configured to measure a surface temperature of the first rotating body,
the second measurement unit is a temperature sensor configured to measure a surface temperature of the second rotating body, and
the calculation unit calculates diameter changes of the first rotating body and the second rotating body from the measured surface temperature of each of the first rotating body and the second rotating body, and a rate of thermal expansion of each of the first rotating body and the second rotating body.

7. The apparatus according to claim 4, further comprising:
a frame to which the first rotating body is attached;
a detection unit configured to detect a distortion of the frame; and
a correction unit configured to correct a change in the clearance obtained by the obtaining unit by the distortion detected by the detection unit.

8. The apparatus according to claim 7, wherein the detection unit is one of a strain gauge and a temperature sensor.

9. The apparatus according to claim 8, wherein the adjustment unit includes a columnar and rotatable shaft support part configured to axially support a first rotating shaft of the first rotating body,
the shaft support part is attached with the first rotating shaft being decentered from a center of the shaft support part, and
the axis-to-axis distance is adjusted by rotating the shaft support part.

10. The apparatus according to claim 1, wherein the first rotating body includes:
a columnar drum; and
an elastic transfer member provided on an outer surface of the drum and where the image is formed, and when the print medium is nipped by the first rotating body and the second rotating body, a transfer pressure is created on the print medium by deforming the transfer member.

11. The apparatus according to claim 1, further comprising a setting unit configured to set the clearance in accordance with a type of the print medium.

12. The apparatus according to claim 1, wherein a change in the clearance occurs by temperature changes of the first rotating body and the second rotating body.

13. An adjustment method of a printing apparatus that includes a first rotating body on which an image is formed by a printhead, a second rotating body configured to convey a print medium, and a transfer unit configured to transfer the image formed on the first rotating body to the print medium conveyed by the second rotating body and print the image, the method comprising:
obtaining a clearance between the first rotating body and the second rotating body; and
adjusting an axis-to-axis distance between a rotating shaft of the first rotating body and a rotating shaft of the second rotating body based on the clearance by the obtaining.

14. The method according to claim 13, further comprising comparing the clearance by the obtaining with a predetermined threshold,
wherein in the adjusting, the axis-to-axis distance is adjusted if a change in the clearance exceeds the predetermined threshold as a result of the comparing.

15. The method according to claim 13, wherein in the obtaining, a diameter of the first rotating body is measured, a diameter of the second rotating body is measured, and the clearance is calculated based on the measured diameter of the first rotating body and the measured diameter of the second rotating body.

16. The method according to claim 15, wherein in measurement of the diameter of the first rotating body, a first change amount from an initial value of the diameter of the first rotating body is measured,
in measurement of the diameter of the second rotating body, a second change amount from an initial value of the diameter of the second rotating body is measured, and
in the calculation, a clearance change amount of the clearance is calculated based on the measured first change amount and the measured second change amount.

17. The method according to claim 13, wherein a columnar and rotatable shaft support part configured to axially support a first rotating shaft of the first rotating body is attached with the first rotating shaft being decentered from a center of the shaft support part, and
in the adjusting, the axis-to-axis distance is adjusted by rotating the shaft support part.

18. The method according to claim 13, further comprising setting the clearance in accordance with a type of the print medium.

19. The method according to claim 13, wherein a change in the clearance occurs by temperature changes of the first rotating body and the second rotating body.
